(19) United States
(12) Patent Application Publication
(10) Pub. No.: US 2024/0323777 A1
(43) Pub. Date: Sep. 26, 2024

(54) RANDOM ACCESS FOR LOWER LAYER SIGNAL BASED MOBILITY

(71) Applicant: Samsung Electronics Co., Ltd., Suwon-si (KR)

(72) Inventors: Anil Agiwal, Allen, TX (US); Shiyang Leng, Allen, TX (US); Kyeongin Jeong, Allen, TX (US)

(21) Appl. No.: 18/603,055

(22) Filed: Mar. 12, 2024

Related U.S. Application Data
(60) Provisional application No. 63/454,237, filed on Mar. 23, 2023.
(60) Provisional application No. 63/456,699, filed on Apr. 3, 2023.
(60) Provisional application No. 63/463,197, filed on May 1, 2023.

(51) Int. Cl. H04W 36/00; H04W 36/08

(52) U.S. Cl. CPC H04W 36/0072; H04W 36/08

(57) ABSTRACT

Methods and apparatuses for a random access for lower layer signal based mobility in a wireless communication system. A method of a UE comprises: receiving an RRC reconfiguration message including a set of configurations of candidate cells for LTM; receiving an early TA command for acquisition of an early TA, the early TA command indicating a candidate cell configuration index; identifying, based on the RRC reconfiguration message, a configuration from the set of configurations associated with the candidate cell configuration index; and transmitting, based on the configuration, a RA preamble for the acquisition of the early TA for a candidate cell associated with the candidate cell configuration index.

### CROSS-REFERENCE TO RELATED APPLICATIONS AND CLAIM OF PRIORITY

The present application claims priority to:
U.S. Provisional Patent Application No. 63/454,237, filed on Mar. 23, 2023;
U.S. Provisional Patent Application No. 63/456,699, filed on Apr. 3, 2023; and
U.S. Provisional Patent Application No. 63/463,197, filed on May 1, 2023. The contents of the above-identified patent documents are incorporated herein by reference.

### TECHNICAL FIELD

The present disclosure relates generally to wireless communication systems and, more specifically, the present disclosure relates to a random access procedure for a lower layer signaling based mobility control in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a random access procedure for a lower layer signaling based mobility control in a wireless communication system.

In one embodiment, a user equipment (UE) in a wireless communication system is provided. The UE comprises a transceiver configured to: receive a radio resource control (RRC) reconfiguration message including a set of configurations of candidate cells for layer 1/layer 2-triggered mobility (LTM) and receive an early timing advance (TA) command for acquisition of an early TA, the early TA command indicating a candidate cell configuration index. The UE further includes a processor operably coupled to the transceiver, the processor configured to: identify, based on the RRC reconfiguration message, a configuration from the set of configurations associated with the candidate cell configuration index, and wherein the transceiver is further configured to transmit, based on the configuration, a random access (RA) preamble for the acquisition of the early TA for a candidate cell associated with the candidate cell configuration index.

In another embodiment, a method of a UE in a wireless communication system is provided. The method comprises: receiving, an RRC reconfiguration message including a set of configurations of candidate cells for LTM; receiving an early TA command for acquisition of an early TA, the early TA command indicating a candidate cell configuration index; identifying, based on the RRC reconfiguration message, a configuration from the set of configurations associated with the candidate cell configuration index; and transmitting, based on the configuration, a RA preamble for the acquisition of the early TA for a candidate cell associated with the candidate cell configuration index.

In yet another embodiment, a base station (BS) in a wireless communication system is provided. The BS comprises a processor. The BS further comprises a transceiver operably coupled to the processor, the transceiver configured to: transmit, an RRC reconfiguration message including a set of configurations of candidate cells for LTM, transmit an early TA command for acquisition of an early TA, the early TA command indicating a candidate cell configuration index, wherein a configuration from the set of configurations associated with the candidate cell configuration index is identified based on the RRC reconfiguration message, and receive, based on the configuration, a RA preamble for the acquisition of the early TA for a candidate cell associated with the candidate cell configuration index.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to embodiments of the present disclosure;

FIGS. 6A to 7C illustrate examples of a lower layer based mobility procedures according to embodiments of the present disclosure;

FIGS. 8 and 9 illustrate examples of UE method for preamble power for advance TA maintenance according to embodiments of the present disclosure;

FIG. 10 illustrates an example of UE method for a lower layer signaling based mobility procedures according to embodiments of the present disclosure; and

FIG. 11 illustrates an example of UE method for a random access procedure with a lower layer signaling based mobility control according to embodiments of the present disclosure.

### DETAILED DESCRIPTION

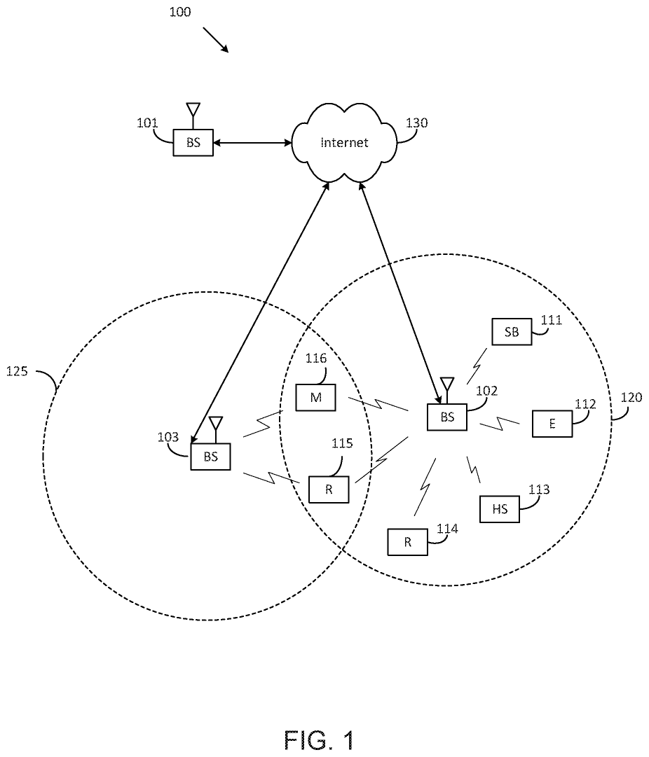

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a random access procedure for a lower layer signaling based mobility control in a wireless communication system. In certain embodiments, and one or more of the gNBs 101-103 includes circuitry, programing, or a combination thereof, to support a random access procedure for a lower layer signaling based mobility control in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

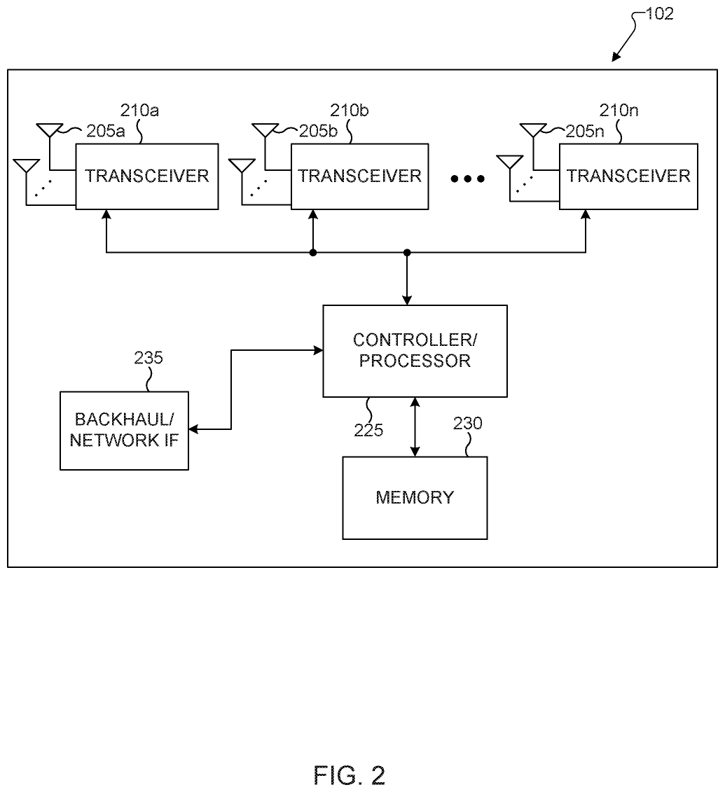

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes to support a random access procedure for a lower layer signaling based mobility control in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

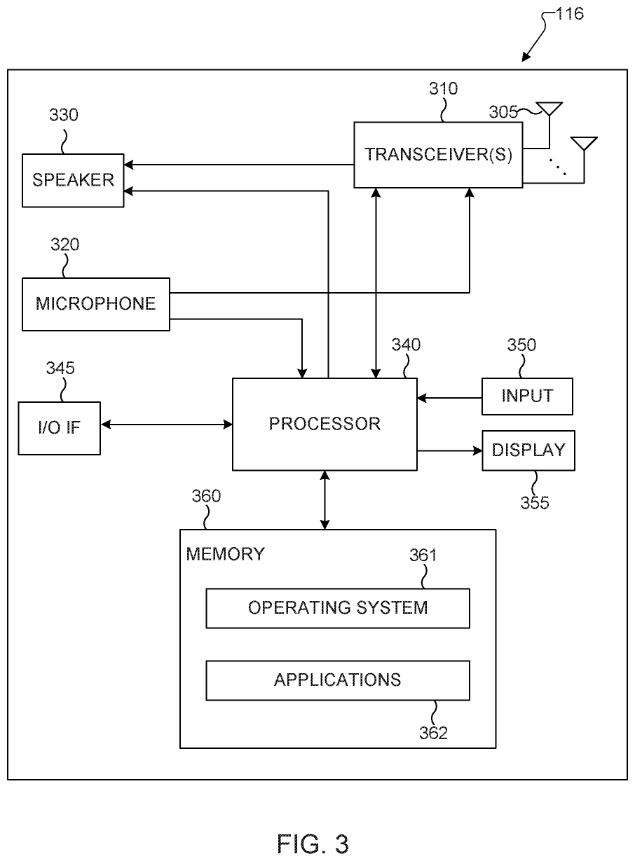

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a random access procedure for a lower layer signaling based mobility control in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

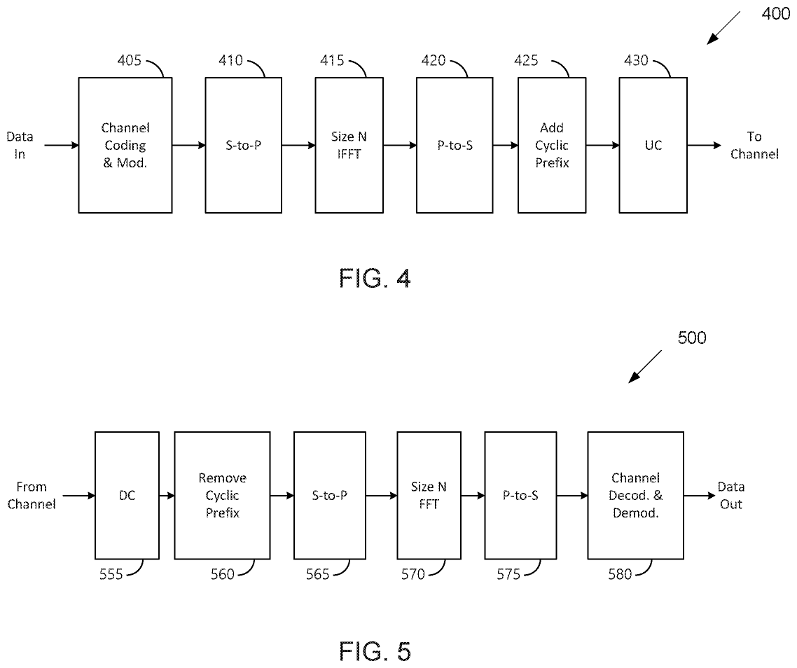

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support a random access procedure for a lower layer signaling based mobility control in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In one embodiment, a lower layer mobility control is provided. In this embodiment, a new type of lower layer mobility also referred as L1/L2-triggered mobility (LTM) is provided. The lower layer mobility is based on L1 measurements that are provided by the UE to the serving cell. Based on this measurement, handover is triggered by sending L1 (e.g., DCI) or L2 (e.g., medium access control-control element (MAC CE)) command. In lower layer mobility, the serving cell change is triggered based on L1 beam measurements instead of L3 cell power and quality measurements that are configured in NR baseline handover of Rel. 15. L3 cell quality measurements are reported only after some time-to-trigger (TTT) expires for a measurement event. L3 measurements also filtered based on L3 configuration over multiple measurements before reporting.

L1 measurements have the benefit that the network can react faster to radio link degradation in the serving link as the network can save the delay introduced by L3 filtering and TTT for the handover decision. This may result in reducing in the number of radio link failures compared to baseline handover. In the legacy handover, an RRC procedure delay consists of an RRC signal processing related to decoding of handover command and L2/3 reconfiguration of the protocol layers.

For lower layer mobility, an RRC procedure delay can be reduced given that the UE can receive and decode the configuration of the target cells before the cell change occurs. Moreover, since lower layer mobility is restricted to intra-CU scenario with same PDCP and RRC, L2/3 reconfigurations can be minimized by keeping the same configuration for PDCP and RRC and possibly other layers such as RLC and MAC in intra-DU scenario, i.e., in inter-DU scenario the new target cell may have different configurations for RLC and MAC. In the best case for intra-DU, the target cell can reconfigure only the new C-RNTI which can save the entire L2/3 reconfiguration for the UE. In legacy handover there is delay due to RF/baseband retuning, derivation of target gNB security keys and configuration of the security algorithm to be used in the target cell. These can also be avoided in lower layer mobility. Given that the PDCP entity in the CU is the same for both source and target cells, the same security keys and algorithms can be applied which reduces the interruption time.

In the legacy handover, there is interruption due to uncertainty in acquiring the first available PRACH occasion in the new cell. In addition, there are the interruptions of sending PRACH preamble and receiving the RACH response (RAR). These random access related interruption components can be reduced in lower layer mobility by introducing RACH-less handover where the UE skips the entire random-access procedure to the target cell. The issue is that upon receiving the cell switch command, how the UE determines whether the UE performs random access procedure towards the target cell or not. This was not an issue in legacy handover as the UE performs random access towards the target cell.

In the legacy handover, there is interruption due to uncertainty in acquiring the first available PRACH occasion in the new cell. In addition, there are the interruptions of sending PRACH preamble and receiving the RACH response (RAR). These random access related interruption components can be reduced in Lower Layer Mobility by introducing RACH-less handover where the UE skips the entire random-access procedure to the target cell. The issue is that upon receiving the cell switch command, how the UE determines whether the UE performs random access procedure towards the target cell or not. This was not an issue in legacy handover as the UE performs random access towards the target cell.

In legacy RA, a UE receives UL grant in RAR for PDCCH ordered CFRA and the UE uses the UL grant for UL transmission after RA completion. In case of advance TA, candidate is not yet serving cell, how to use/handle UL grant received in RAR.

In legacy RA, a UE receives RAR from SpCell. In case of RA initiated for advanced TA receiving RAR from SpCell can be complex for inter DU scenario. Interaction between source DU and target DU is needed.

In the existing design, when TAT of PTAG expires, MAC entity (note that there is separate MAC entity for MCG and SCG in UE) in a UE stops all running TATs in that MAC entity. TATs associated with serving cell as well as the TATs associated with LTM candidate cell(s) for which TA is established are stopped. This is not the desired behavior for L1/L2 triggered mobility. This operation may require network (i.e., gNB) to unnecessarily send PDCCH order to establish early TA for non-serving cell again or the UE may perform RACH upon receiving cell switch command. This leads to unnecessary signaling overhead and increased latency for LTM if TA could not be re-established again before the cell switch command is sent.

In one embodiment, followings are provide: (1) new triggers for a UE to initiate or not initiate RA upon receiving L1/L2 cell switch command; (2) details of advance TA maintenance (candidate cell identification, carrier selection, BWP selection, power ramping aspects, signaling between source DU and target DU); (3) an indication from a gNB to determine whether to receive RAR from SpCell or Candidate cell; (4) handling UL grant received in RAR during advance TA management, indication to discard or store this UL grant, usage of this UL grant for confirmation upon cell switch; (5) multiple PreambleTransMax configuration and usage depending on whether RA is for advance TA or not; (6) a BWP configuration for advanced TA; and (7) PTAG's TAT expiry handling for LTM.

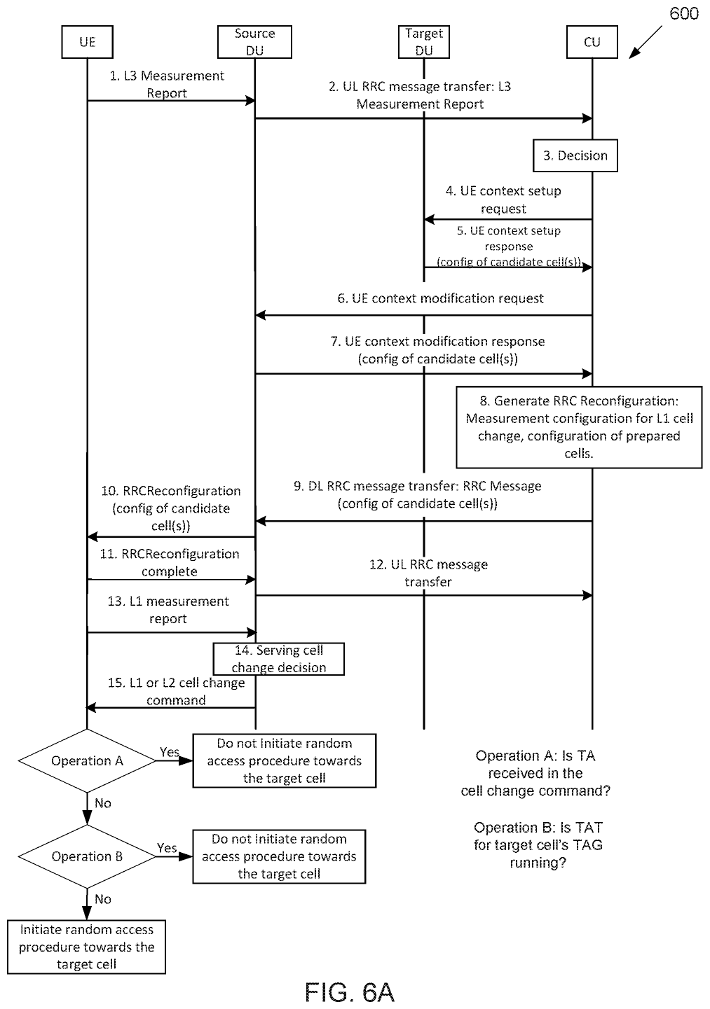

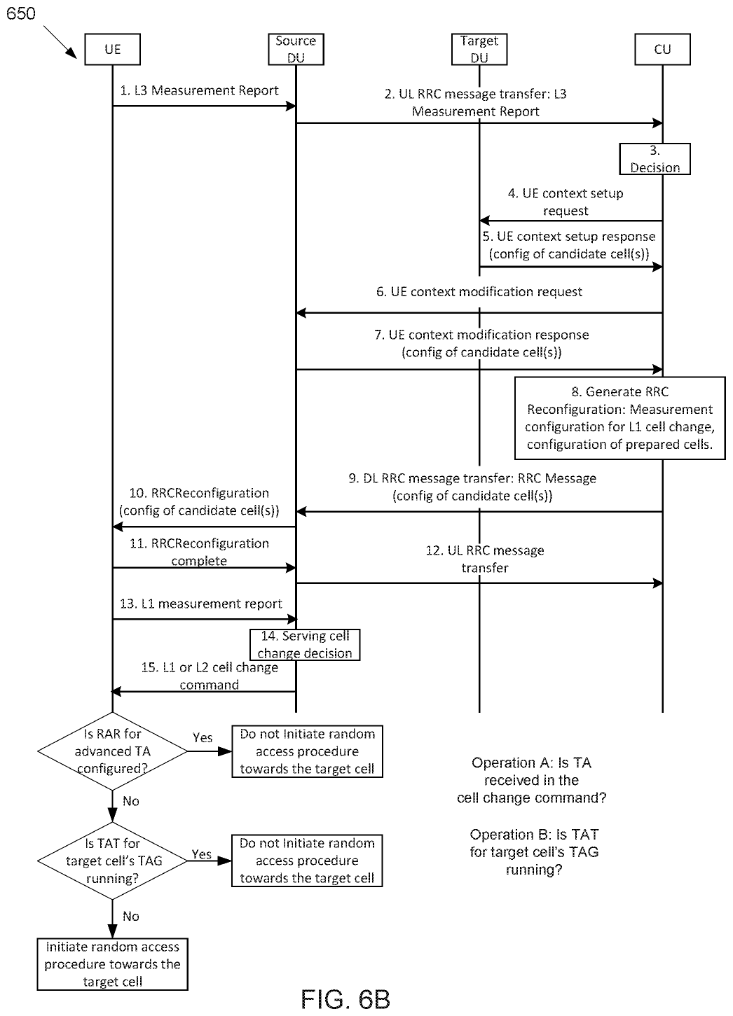

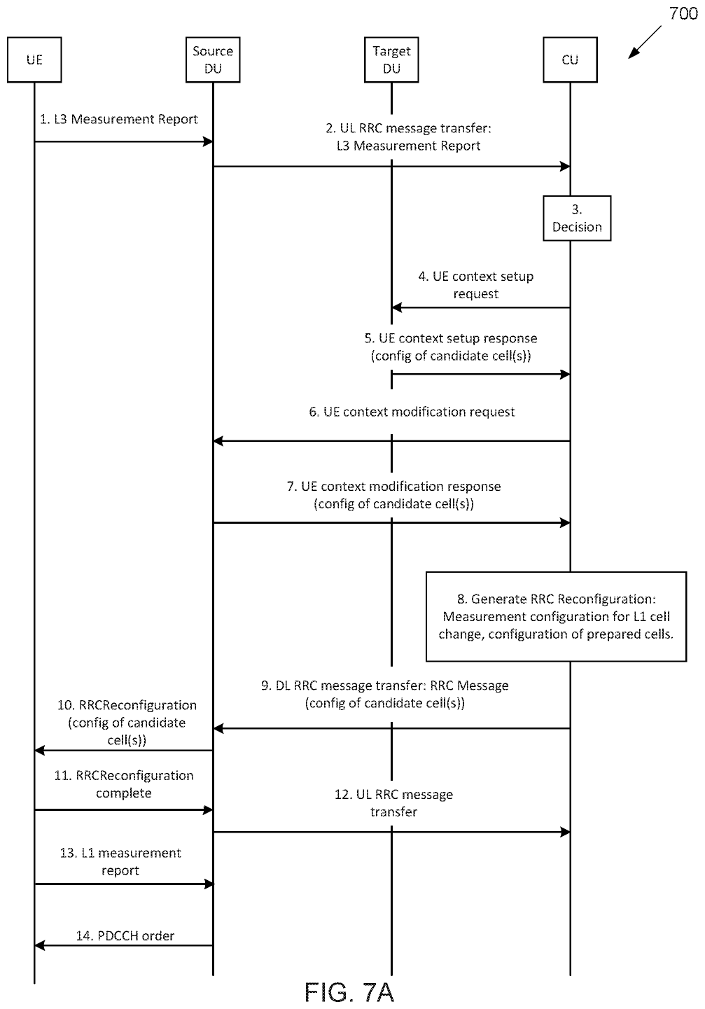

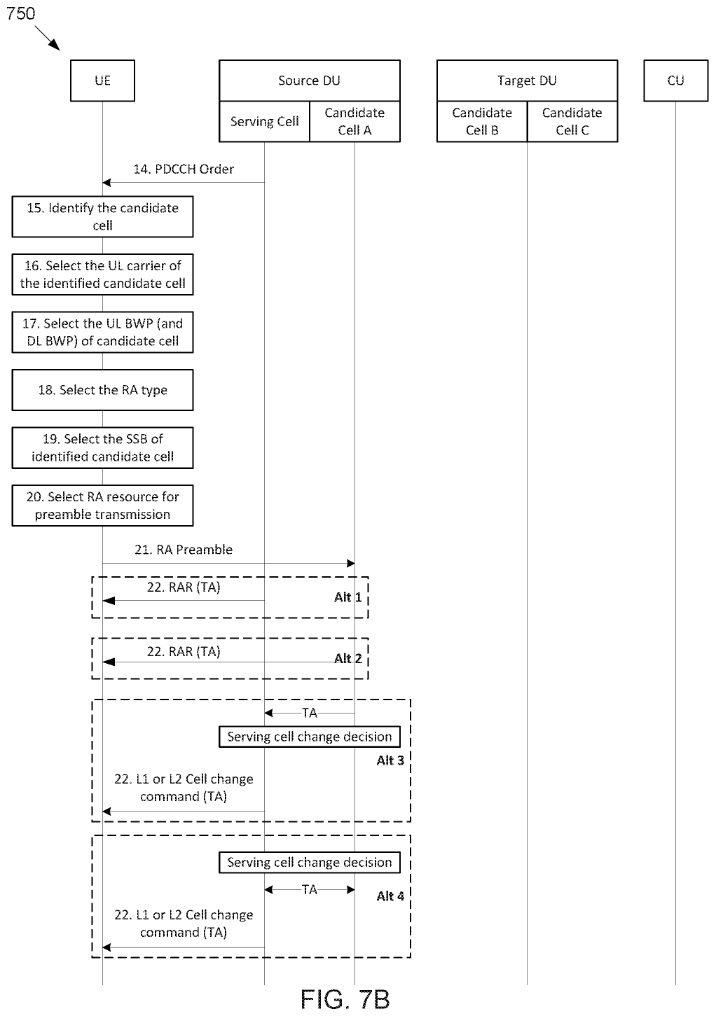

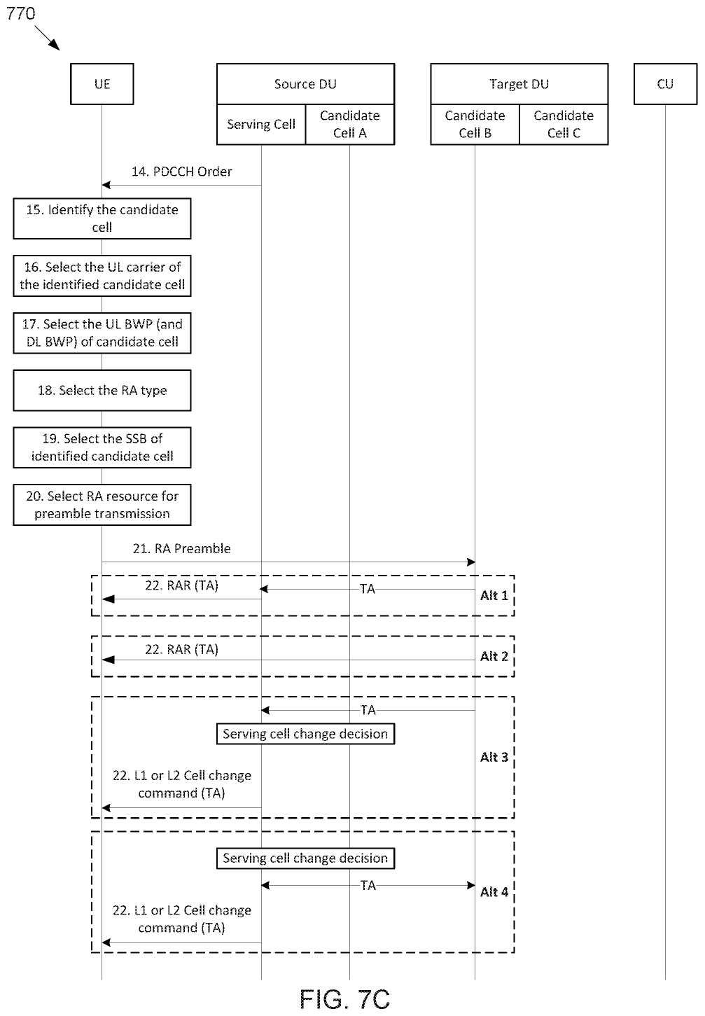

FIGS. 6A to 7C illustrate examples of a lower layer based mobility procedures 600, 650, 700, 750, and 770 according to embodiments of the present disclosure. The procedures 600, 650, 700, 750, and 770 as may be performed by a UE (e.g., 111-116 as illustrated in FIG. 1) and a base station (e.g., 101-103 as illustrated in FIG. 1). An embodiment of the procedures 600, 650, 700, 750, and 770 shown in FIGS. 6A to 7C are for illustration only. One or more of the components illustrated in FIGS. 6A to 7C can be implemented in specialized circuitry configured to perform the noted functions or one or more of the components can be implemented by one or more processors executing instructions to perform the noted functions.

As illustrated in FIG. 6A, the lower layer based mobility procedure 600 is illustrated. In FIG. 6A, a UE sends a measurement report containing the measurements of serving and target cell(s) in step 1 and 2. A measurement report is sent to a serving cell. Serving DU of the serving cell then forwards the report to CU. The measurement report can be based on L3 measurements or L1 measurements. Based on the reported measurements, the CU may identify a potential set of candidate target cells to which the UE can be handed over to in step 3. In this example, the CU identifies candidate target cells that are served by either source DU or another DU (i.e., target DU) which are controlled by the same CU.

The CU requests the preparation of a candidate target cell controlled by the target DU by sending a UE context setup request message in step 4. The target DU provides the configuration of the UE in a UE context setup response messages, respectively, containing a container from DU to CU in step 5. The configuration may contain UE-specific and non-UE-specific parts. Note that step 4 and step 5 are not performed if candidate target cells of other DU are not identified in step 3.

The configuration may include 4 step RA configuration (rach-ConfigCommon) and/or 2 step RA configuration (msgA-ConfigCommon) besides other configuration. These RA configurations of candidate target cell are BWP specific and may be included in the respective BWP configuration of that candidate target cell.

The CU requests the preparation of a candidate target cell controlled by the source DU by sending a UE context modification request message in step 6. The source DU provides the configuration of the UE in a UE context modification response message containing a container from DU to CU in step 7. The configuration may contain UE-specific and non-UE-specific parts. Note that step 6 and step 7 are not performed if candidate target cells of source DU are not identified in step 3.

The configuration may include 4 step RA configuration (rach-ConfigCommon) and/or 2 step RA configuration (msgA-ConfigCommon) besides other configuration. These RA configurations of candidate target cell are BWP specific and may be included in the respective BWP configuration of that candidate target cell.

Upon receiving the UE configurations for the candidate target cell(s), the CU generates an RRC Reconfiguration (in step 8) including the configuration of candidate target cell(s) for L1 or L2 triggered mobility (LTM) that is sent to the UE in step 9/10. The RRC Reconfiguration may include separate RRC Reconfiguration IE for each of candidate target cell(s) or CellGroupConfig 1E for each of candidate target cell(s). CU sends the configuration to source DU which then sends the configuration to the UE. Among other information, the RRC reconfiguration message contains: a measurement reporting configuration for L1/L2 mobility, i.e., configuration on how to report the L1 beam measurements of serving and target cells; configuration of the prepared candidate cell(s) which the UE needs to execute when the UE receives a L1/L2 command to change the serving cell, such as random access configuration as described earlier, radio bearer configurations, indication of whether to perform PDCP re-establishment or not (per DRB or common for all), indication of whether to perform PDCP level data recovery or not (per DRB or common for all), indication of whether to perform RLC re-establishment or not (per DRB or RLC channel or common for all), indication of whether to perform MAC reset or partial MAC reset or not, etc. RRC Reconfiguration may also include firstActiveUplinkBWP and firstActiveDownlinkBWP for each prepared candidate cell(s) and list of DL and UL BWP configurations for each prepared candidate cell(s).

An RRC Reconfiguration may also include InitialUplinkBWP and InitialDownlinkBWP for each prepared candidate cell(s) and list of DL and UL BWP configurations for each prepared candidate cell(s). In addition to including separate RRCReconfiguration IE for each of the candidate cells for LTM, the RRCReconfiguration message also includes RACH configuration for early TA maintenance for one or more candidate cells for LTM. A list of RACH configurations may be included in the RRCReconfiguration message for early TA maintenance wherein each RACH configuration in list corresponds to a candidate cell (candidate cell id or PCI is used to identify the corresponding candidate cell). BWP configuration associated with each RACH configuration for early TA maintenance is also included the RRCReconfiguration message. So basically, for each candidate cell for LTM, the RRCReconfiguration message includes RRCReconfiguration IE (consisting of candidate cell configuration to be used upon switching), RACH configuration for early TA maintenance (consisting of RA configuration/parameters to be applied when RA for early TA is initiated) and UL (and/or DL) BWP configuration for early TA maintenance (consisting of BWP information to be applied when RA for early TA is initiated).

Note that the candidate cell configuration for early TA (RACH configuration, BWP configuration etc.) is separate from candidate cell configuration included in RRCReconfiguration IE. Candidate cell configuration included in RRCReconfiguration IE is applied after cell switch command is received. Candidate cell configuration for early TA is applied before cell switch command.

For each candidate cell (identified by candidate cell index or physical cell ID or PCI) for LTM, in addition RRCReconfiguration IE, for early TA for the candidate cell, an RRCReconfiguration message includes following for NUL and/or SUL of the candidate cell: BWP configuration (BWP-UplinkCommon IE which includes subcarrierSpacing; location AndBandwidth i.e., Frequency domain location and bandwidth of this bandwidth part, the first PRB of BWP is a PRB determined by subcarrierSpacing of this BWP and offsetToCarrier; and RACH configuration), absoluteFrequencyPointA i.e., absolute frequency of the reference resource block (Common RB 0) for UL carrier, it lowest subcarrier is also known as Point A, offsetToCarrier i.e., an offset in frequency domain between Point A (lowest subcarrier of common RB 0) and the lowest usable subcarrier on this carrier in number of PRBs (using the subcarrierSpacing defined for this carrier). So basically, a list of [candidate cell id, BWP configuration and carrier configuration] for early TA may be included in the RRCReconfiguration message. In an embodiment, instead of BWP configuration for early TA, BWP ID may be included which refers to BWP amongst the BWP configurations of candidate cell in the RRCReconfiguration IE of that candidate cell.

The UE confirms the RRC reconfiguration to the network in step 11 and 12.

After confirming the RRC reconfiguration to the network, the UE starts to report the L1 beam measurement of serving and candidate target cells as in step 13. Based on measurements, the serving cell may decide to trigger cell change command in step 14. In an example, upon determining that there is a target candidate cell having a better radio link/beam measurement than the serving cell (step 14), e.g., L1-RSRP of target beam measurement>L1-RSRP of serving beam measurement+Offset for a time period (i.e., Time-to-Trigger (TTT) period), the serving cell sends a L1 or L2 cell change/switch command in step 15 to trigger the cell change to the target candidate cell. It is to be noted that RRCReconfiguration may also be sent based on the measurements received in step 13 and later when condition for cell change is met, serving cell sends a L1 or L2 cell change/switch command.

Between step 12 and step 14, the serving cell may send command (e.g., PDCCH order) to the UE to perform RA towards a candidate cell (for early TA). In an embodiment, a UE initiates RA using RACH configuration configured for early TA of the candidate cell and uses the UL BWP configured for early TA for RA/MsgA preamble transmission. This can be repeated for one or more candidate cells received in step 10. Based on the random access preamble received from UE, candidate cell determines the TA value.

A candidate cell provides the determined TA to the UE in response (e.g., in RAR or in MAC CE). If the UE receives the TA value, the UE may start timing alignment timer for the TAG of the candidate cell and stores the received TA. The stored value of TA is removed if the timing alignment timer expires.

Alternatively, a candidate cell can provide the TA value to source cell which then sends the value to the UE later in L1 or L2 cell change/switch command (MAC CE or DCI). Alternatively, the candidate cell stores the TA value and when source cell decides to switch the UE to this candidate cell it asks the candidate cell for TA value and the TA value received by source cell from candidate cell is sent by the source cell to the UE in L1 or L2 cell change/switch command (MAC CE or DCI). Alternately, candidate cell stores the TA value and when source cell asks the candidate cell for TA value the candidate cell sends the same to source cell and the TA value received by source cell from candidate cell is sent by the source cell to the UE in L1 or L2 cell change/switch command (MAC CE or DCI).

Upon receiving the L1 or L2 cell change/switch command (MAC CE or DCI) to switch to a target cell amongst the candidate cell(s) received in step 10, a UE determines whether to perform random access towards the target cell or not as follows: (2) If TA is included in L1 or L2 cell change/switch command (MAC CE or DCI) or if TAT is running for target cell (or for TAG of target cell): (i) UE does not initiate random access towards the target cell, (ii) Else, the UE initiates random access towards the target cell.

An L1 or L2 cell change/switch command (MAC CE or DCI) to switch to a target cell amongst the candidate cell(s) may include UL grant. A UE uses this UL grant to send confirmation (i.e., first UL transmission to cell UE switches (i.e., cell indicated in cell switch command) after switching. In an embodiment, the UL grant may be included in L1 or L2 cell change/switch command (MAC CE or DCI) which does not trigger RA.

A candidate cell configuration (e.g., as received in step 10) may include RACH configuration for one or more BWPs. The RACH configuration may include a first and second configuration of PreambleTransMax parameter which indicates maximum number of preamble transmissions allowed during the random access procedure. If a random access procedure is initiated for the candidate cell after receiving the candidate cell configuration and before the cell switching is indicated to a UE to switch to this candidate cell, the UE uses the first configuration of PreambleTransMax parameter (from the BWP configuration of BWP selected for random access procedure).

If a random access procedure is initiated for the candidate cell after the cell switching is indicated to the UE to switch to this candidate cell, the UE uses the second configuration of PreambleTransMax parameter (from the BWP configuration of BWP selected for random access procedure). Based on first configuration of PreambleTransMax the UE can transmit number of preambles indicated by PreambleTransMax without waiting for RAR. Based on second configuration of PreambleTransMax, the UE can transmit up to a number of preambles indicated by PreambleTransMax, but the preamble transmission is performed only if RAR reception fails, or contention resolution fails during the random access procedure.

As illustrated in FIG. 6B, the lower layer based mobility procedure 650 is illustrated. In FIG. 6B, a UE sends a measurement report containing the measurements of serving and target cell(s) in step 1 and 2. Measurement report is sent to serving cell. Serving DU of serving cell then forwards the report to CU. The measurement report can be based on L3 measurements or L1 measurements. Based on the reported measurements, the CU may identify a potential set of candidate target cells to which the UE can be handed over to in step 3. In this example, the CU identifies candidate target cells that are served by either source DU or another DU (i.e., target DU) which are controlled by the same CU.

The CU requests the preparation of a candidate target cell controlled by the target DU by sending a UE context setup request message in step 4. The target DU provides the configuration of the UE in a UE context setup response messages, respectively, containing a container from DU to CU in step 5. The configuration may contain UE-specific and non-UE-specific parts. Note that step 4 and step 5 are not performed if candidate target cells of other DU are not identified in step 3.

The configuration may include 4 step RA configuration (rach-ConfigCommon) and/or 2 step RA configuration (msgA-ConfigCommon) besides other configuration. These RA configurations of candidate target cell are BWP specific and may be included in the respective BWP configuration of that candidate target cell.

The CU requests the preparation of a candidate target cell controlled by the source DU by sending a UE context modification request message in step 6. The source DU provides the configuration of the UE in UE context modification response message containing a container from DU to CU in step 7. The configuration may contain UE-specific and non-UE-specific parts. Note that step 6 and step 7 are not performed if candidate target cells of source DU are not identified in step 3.

The configuration may include 4 step RA configuration (rach-ConfigCommon) and/or 2 step RA configuration (msgA-ConfigCommon) besides other configuration. These RA configurations of candidate target cell are BWP specific and may be included in the respective BWP configuration of that candidate target cell.

Upon receiving the UE configurations for the candidate target cell(s), the CU generates an RRC Reconfiguration (in step 8) including the configuration of candidate target cell(s) for L1 or L2 triggered mobility (LTM) that is sent to the UE in step 9/10. The RRC Reconfiguration may include separate RRC Reconfiguration IE for each of candidate target cell(s) or CellGroupConfig 1E for each of candidate target cell(s). CU sends the configuration to source DU which then sends the configuration to the UE. Among other information, the RRC reconfiguration message contains: a measurement reporting configuration for L1/L2 mobility, i.e., configuration on how to report the L1 beam measurements of serving and target cells; Configuration of the prepared candidate cell(s) which the UE needs to execute when the UE receives a L1/L2 command to change the serving cell, such as random access configuration as described earlier, radio bearer configurations, indication of whether to perform PDCP re-establishment or not (per DRB or common for all), indication of whether to perform PDCP level data recovery or not (per DRB or common for all), indication of whether to perform RLC re-establishment or not (per DRB or RLC channel or common for all), indication of whether to perform MAC reset or partial MAC reset or not, etc. RRC Reconfiguration may also include firstActiveUplinkBWP and firstActiveDownlinkBWP for each prepared candidate cell(s) and list of DL and UL BWP configurations for each prepared candidate cell(s).

An RRC Reconfiguration may also include InitialUplinkBWP and InitialDownlinkBWP for each prepared candidate cell(s) and list of DL and UL BWP configurations for each prepared candidate cell(s). In addition to including separate RRCReconfiguration IE for each of the candidate cells for LTM, the RRCReconfiguration message also includes RACH configuration for early TA maintenance for one or more candidate cells for LTM. A list of RACH configurations may be included in the RRCReconfiguration message for early TA maintenance wherein each RACH configuration in list corresponds to a candidate cell (candidate cell id or PCI is used to identify the corresponding candidate cell). BWP configuration associated with each RACH configuration for early TA maintenance is also included the RRCReconfiguration message.

So basically, for each candidate cell for LTM, the RRCReconfiguration message includes RRCReconfiguration IE (consisting of candidate cell configuration to be used upon switching), RACH configuration for early TA maintenance (consisting of RA configuration/parameters to be applied when RA for early TA is initiated) and UL (and/or DL) BWP configuration for early TA maintenance (consisting of BWP information to be applied when RA for early TA is initiated). Note that candidate cell configuration for early TA (RACH configuration, BWP configuration etc.) is separate from candidate cell configuration included in an RRCReconfiguration IE. Candidate cell configuration included in the RRCReconfiguration IE is applied after cell switch command is received. Candidate cell configuration for early TA is applied before cell switch command.

For each candidate cell (identified by candidate cell index or physical cell ID or PCI) for LTM, in addition RRCReconfiguration IE, for early TA for the candidate cell, an RRCReconfiguration message includes following for NUL and/or SUL of the candidate cell: BWP configuration (BWP-UplinkCommon IE which includes subcarrierSpacing; locationAndBandwidth i.e., Frequency domain location and bandwidth of this bandwidth part, the first PRB of BWP is a PRB determined by subcarrierSpacing of this BWP and offsetToCarrier; and RACH configuration), absoluteFrequencyPointA i.e., Absolute frequency of the reference resource block (Common RB 0) for UL carrier, it lowest subcarrier is also known as Point A, offsetToCarrier i.e., Offset in frequency domain between Point A (lowest subcarrier of common RB 0) and the lowest usable subcarrier on this carrier in number of PRBs (using the subcarrierSpacing defined for this carrier). So basically, a list of [candidate cell id, BWP configuration and carrier configuration] for early TA may be included in the RRCReconfiguration message. In an embodiment, instead of BWP configuration for early TA, BWP ID may be included which refers to BWP amongst the BWP configurations of candidate cell in the RRCReconfiguration IE of that candidate cell.

The UE confirms the RRC reconfiguration to the network in step 11 and 12.

After confirming the RRC reconfiguration to the network, the UE starts to report the L1 beam measurement of serving and candidate target cells as in step 13. Based on measurements serving cell may decide to trigger cell change command in step 14. In an example, upon determining that there is a target candidate cell having a better radio link/beam measurement than the serving cell (step 14), e.g., L1-RSRP of target beam measurement>L1-RSRP of serving beam measurement+Offset for a time period (i.e., Time-to-Trigger (TTT) period), the serving cell sends a L1 or L2 cell change/switch command in step 15 to trigger the cell change to the target candidate cell. It is to be noted that RRCReconfiguration may also be sent based on the measurements received in step 13 and later when condition for cell change is met, serving cell sends a L1 or L2 cell change/switch command.

Between step 12 and step 14, serving cell may send command (e.g., PDCCH order) to a UE to perform RA towards a candidate cell for advance TA maintenance. In an embodiment, a UE initiates RA using RACH configuration configured for early TA of the candidate cell and uses the UL BWP configured for early TA for RA/MsgA preamble transmission. This may be repeated for one or more candidate cells received in step 10. Based on the random access preamble received from UE, candidate cell determines the TA value. Candidate cell provides the same to the UE in response (e.g., in RAR or in MAC CE). If the UE receives the TA value, the UE may start timing alignment timer for the TAG of candidate cell and stores the received TA. The stored value of TA is removed if the timing alignment timer expires.

Whether a network sends response (RAR or MAC CE) or not for advance TA maintenance can be configured by RRC (e.g., in an RRCReconfiguration message or it can be pre-defined. In an embodiment, response (RAR or MAC CE) is not configured for advance TA maintenance, in this case TA value is not sent to a UE in response to random access for advance TA. Candidate cell can provide the TA value to source cell which then sends the value to the UE in L1 or L2 cell change/switch command (MAC CE or DCI). Alternately, candidate cell stores the TA value and when source cell decides to switch the UE to this candidate cell it asks the candidate cell for TA value and the TA value received by source cell from candidate cell is sent by the source cell to the UE in L1 or L2 cell change/switch command (MAC CE or DCI).

Upon receiving the L1 or L2 cell change/switch command (MAC CE or DCI) to switch to a target cell amongst the candidate cell(s) received in step 10, a UE determines whether to perform random access towards the target cell or not as follows: (1) if RAR for advanced TA maintenance is not configured by RRC (i.e., TA is indicated in LTM triggering MAC CE) OR if TAT is running for target cell (or for TAG of target cell A): a UE does not initiate random access towards the target cell; and (2) Else, a UE initiates random access towards the target cell.

If RAR is always used to deliver TA for advanced TA maintenance, upon receiving the L1 or L2 cell change/switch command (MAC CE or DCI) to switch to a target cell amongst the candidate cell(s) received in step 10, a UE determines whether to perform random access towards the target cell or not as follows: (1) if TAT is running for target cell (or for TAG of target cell A): a UE does not initiate random access towards the target cell and (2) Else, the UE initiates random access towards the target cell.

An L1 or L2 cell change/switch command (MAC CE or DCI) to switch to a target cell amongst the candidate cell(s) may include UL grant. A UE uses this UL grant to send confirmation (i.e., first UL transmission to cell UE switches (i.e., cell indicated in cell switch command) after switching. In an embodiment, the UL grant may be included in L1 or L2 cell change/switch command (MAC CE or DCI) which does not trigger RA.

As illustrated in FIGS. 7A and 7B, a UE sends a measurement report containing the measurements of serving and target cell(s) in step 1 and 2. A measurement report is sent to serving cell. Serving DU of serving cell then forwards the report to CU. The measurement report can be based on L3 measurements or L1 measurements. Based on the reported measurements, the CU may identify a potential set of candidate target cells to which the UE can be handed over to in step 3. In this example, the CU identifies candidate target cells that are served by either source DU or another DU (i.e., target DU) which are controlled by the same CU.

The CU requests the preparation of a candidate target cell controlled by the target DU by sending a UE context setup request message in step 4. The target DU provides the configuration of the UE in a UE context setup response messages, respectively, containing a container from DU to CU in step 5. The configuration may contain UE-specific and non-UE-specific parts. Note that step 4 and step 5 are not performed if candidate target cells of other DU are not identified in step 3.

The configuration may include 4 step RA configuration (rach-ConfigCommon) and/or 2 step RA configuration (msgA-ConfigCommon) besides other configuration. These RA configurations of candidate target cell are BWP specific and may be included in the respective BWP configuration of that candidate target cell.

The CU requests the preparation of a candidate target cell controlled by the source DU by sending a UE context modification request message in step 6. The source DU provides the configuration of the UE in a UE context modification response message containing a container from DU to CU in step 7. The configuration may contain UE-specific and non-UE-specific parts. Note that step 6 and step 7 are not performed if candidate target cells of source DU are not identified in step 3.

The configuration may include 4 step RA configuration (rach-ConfigCommon) and/or 2 step RA configuration (msgA-ConfigCommon) besides other configuration. These RA configurations of candidate target cell are BWP specific and may be included in the respective BWP configuration of that candidate target cell.

Upon receiving the UE configurations for the candidate target cell(s), the CU generates an RRC Reconfiguration (in step 8) including the configuration of candidate target cell(s) for L1 or L2 triggered mobility (LTM) that is sent to the UE in step 9/10. The RRC Reconfiguration may include separate RRC Reconfiguration IE for each of candidate target cell(s) or CellGroupConfig 1E for each of candidate target cell(s). CU sends the configuration to source DU which then sends the configuration to the UE. Among other information, the RRC reconfiguration message contains: a measurement reporting configuration for L1/L2 mobility, i.e., configuration on how to report the L1 beam measurements of serving and target cells; configuration of the prepared candidate cell(s) which the UE needs to execute when the UE receives a L1/L2 command to change the serving cell, such as random access configuration as described earlier, radio bearer configurations, indication of whether to perform PDCP re-establishment or not (per DRB or common for all), indication of whether to perform PDCP level data recovery or not (per DRB or common for all), indication of whether to perform RLC re-establishment or not (per DRB or RLC channel or common for all), indication of whether to perform MAC reset or partial MAC reset or not, etc.

An RRC Reconfiguration may also include firstActive UplinkBWP and firstActiveDownlinkBWP for each prepared candidate cell(s) and list of DL and UL BWP configurations for each prepared candidate cell(s). RRC Reconfiguration may also include InitialUplinkBWP and InitialDownlinkBWP for each prepared candidate cell(s) and list of DL and UL BWP configurations for each prepared candidate cell(s). In addition to including separate RRCReconfiguration IE for each of the candidate cells for LTM, the RRCReconfiguration message also includes RACH configuration for early TA maintenance for one or more candidate cells for LTM. A list of RACH configurations may be included in the RRCReconfiguration message for early TA maintenance wherein each RACH configuration in list corresponds to a candidate cell (candidate cell id or PCI is used to identify the corresponding candidate cell). BWP configuration associated with each RACH configuration for early TA maintenance is also included the RRCReconfiguration message.

So basically, for each candidate cell for LTM, the RRCReconfiguration message includes RRCReconfiguration IE (consisting of candidate cell configuration to be used upon switching), RACH configuration for early TA maintenance (consisting of RA configuration/parameters to be applied when RA for early TA is initiated) and UL (and/or DL) BWP configuration for early TA maintenance (consisting of BWP information to be applied when RA for early TA is initiated). Note that candidate cell configuration for early TA (RACH configuration, BWP configuration etc.) is separate from candidate cell configuration included in RRCReconfiguration IE. Candidate cell configuration included in RRCReconfiguration IE is applied after cell switch command is received. Candidate cell configuration for early TA is applied before cell switch command.

For each candidate cell (identified by candidate cell index or physical cell ID or PCI) for LTM, in addition RRCReconfiguration IE, for early TA for the candidate cell, RRCReconfiguration message includes following for NUL and/or SUL of the candidate cell: BWP configuration (BWP-UplinkCommon IE which includes subcarrierSpacing; locationAndBandwidth i.e., Frequency domain location and bandwidth of this bandwidth part, the first PRB of BWP is a PRB determined by subcarrierSpacing of this BWP and offsetToCarrier; and RACH configuration), absoluteFrequencyPointA i.e., Absolute frequency of the reference resource block (Common RB 0) for UL carrier, it lowest subcarrier is also known as Point A, offsetToCarrier i.e., Offset in frequency domain between Point A (lowest subcarrier of common RB 0) and the lowest usable subcarrier on this carrier in number of PRBs (using the subcarrierSpacing defined for this carrier). So basically, a list of [candidate cell id, BWP configuration and carrier configuration] for early TA may be included in the RRCReconfiguration message. In an embodiment, instead of BWP configuration for early TA, BWP ID may be included which refers to BWP amongst the BWP configurations of candidate cell in the RRCReconfiguration IE of that candidate cell.

The UE confirms the RRC Reconfiguration to the network in step 11 and 12.

After confirming the RRC Reconfiguration to the network, the UE starts to report the L1 beam measurement of serving and candidate target cells in step 13.

For advance TA maintenance, serving cell may send early TA command (e.g., PDCCH order) to a UE to perform RA towards a candidate cell at step 14. This can be repeated for one or more candidate cells.

The early TA command (e.g., PDCCH order) needs to indicate non serving cell (i.e., cell amongst the candidate cells for L1/L2 triggered mobility or LTM received in step 10). In order to identify/indicate the non-serving cell in PDCCH order: (1) each candidate cell configuration in list of candidate cell configurations can be sequentially numbered/indexed from zero or one. This index is included in PDCCH order to indicate the candidate cell. Reserved bits in PDCCH order can be used for this index; (2) an explicit index can be explicitly signaled in candidate cell configuration. This index is included in PDCCH order to indicate the candidate cell. Reserved bits in PDCCH order can be used for signaling this index; (3) PCI can be included in candidate cell configuration. PCI of candidate cell is included in PDCCH order. Reserved bits in PDCCH order can be used for indicating PCI; and (4) each candidate cell RACH configuration in list of candidate cell RACH configuration for early TA received in an RRC reconfiguration message can be sequentially numbered/indexed. This is index can be included in PDCCH order. Reserved bits in PDCCH order can be used for this index.

In an embodiment, an RA preamble index in the early TA command (e.g., PDCCH order) for advanced TA maintenance for LTM is set to a non-zero value by a gNB. RA preamble index identifies the RA preamble to be used by a UE when the UE initiates RA upon receiving the early TA command (e.g., PDCCH order).

In an embodiment, if SUL is configured in the candidate cell, based on measurements received from a UE, a gNB can identify whether a UE may use UL or SUL for RA and indicate the same in early TA command (e.g., PDCCH order) using the UL/SUL indicator field. If SUL is not configured in the candidate cell, a gNB indicate UL in the early TA command (e.g., PDCCH order) using the UL/SUL indicator field. In alternate embodiment, UL or SUL is not indicated by the early TA command (e.g., PDCCH order). This can be useful in case a network does not have recent information about the DL measurement of this cell. If SUL is configured in candidate cell, the UE selects UL/SUL based on RSRP threshold if early TA command (e.g., PDCCH order) is for LTM (or advanced TA maintenance for LTM). Whether the UE ignore the UL/SUL field in early TA command (e.g., PDCCH order) can be indicated by the gNB using RRC signaling (e.g., in candidate cell configuration in step 10).

In one embodiment, an RACH configuration (e.g., in candidate cell configuration in step 10) for early TA is provided either for SUL or NUL. A UE selects the carrier for which RACH configuration is provided in candidate cell configuration (or the UE selects the carrier for which RACH configuration for early TA is provided for the candidate cell). This is feasible if the network has information about the latest DL measurements results of the candidate cell. One drawback of this approach is that due to time interval between candidate cell configuration signaling and command for early TA, carrier selection performed by the network may not be valid at the time early TA procedure is initiated by the UE.

In an embodiment, an SSB index can be indicated by a gNB in early TA command (e.g., PDCCH order) for LTM (or advanced TA maintenance for LTM). In alternate embodiment, the SSB index is not indicated by the early TA command (e.g., PDCCH order) for LTM (or advanced TA maintenance for LTM) and a UE selects the SSB based on RSRP threshold if PDCCH order is for LTM (or advanced/early TA maintenance for LTM). Whether the UE ignore the SSB index field in PDCCH order can be indicated by the gNB using RRC signaling (e.g., in candidate cell configuration in step 10).

In one embodiment, for early TA management, contention free RACH resources for one or more SSBs are provided by the network in candidate cell configuration (e.g., in candidate cell configuration in step 10). A UE selects an SSB with SS-RSRP above threshold amongst these SSBs. This is feasible if the network has information about the latest DL measurements results of the candidate cell. One drawback of this approach is that due to time interval between candidate cell configuration signaling and command for early TA, SSBs selected by the network may not be valid at the time early TA procedure is initiated by the UE.

Upon receiving the early TA command (e.g., PDCCH order) for LTM (or advanced TA maintenance for LTM): (1) a UE identifies the candidate cell for which RA is to be initiated based on the index/PCI field in the early TA command (e.g., PDCCH order) at step 15; and (2) the UE then selects the UL carrier of the identified candidate cell at step 16.

In an embodiment, if UL/SUL field is included in early TA command (e.g., PDCCH order) for LTM (or advanced TA maintenance for LTM) or if a field in early TA command (e.g., PDCCH order) indicates that UL/SUL field is included in early TA command (e.g., PDCCH order) or if RRC has not indicated a UE to ignore UL/SUL field in early TA command (e.g., PDCCH order) for LTM (or advanced TA maintenance for LTM): the UE selects the UL carrier indicated by UL/SUL field.

In an embodiment, if UL/SUL field is not included in early TA command (e.g., PDCCH order) for LTM (or advanced TA maintenance for LTM) or if RRC has indicated a UE to ignore UL/SUL field in early TA command (e.g., PDCCH order) for LTM (or advanced TA maintenance for LTM) or if a field in early TA command (e.g., PDCCH order) indicates that UL/SUL field is not included in early TA command (e.g., PDCCH order), the UE selects the UL carrier as follows.

if the candidate cell for the random access procedure is configured with supplementary uplink and if the RSRP of the downlink pathloss reference is less than rsrp-ThresholdSSB-SUL: a UE selects the SUL carrier for performing random access procedure. Otherwise, the UE selects the NUL carrier for performing random access procedure.

In one embodiment, an RACH configuration (e.g., in candidate cell configuration in step 10) for early TA is provided either for SUL or NUL. A UE selects the carrier for which RACH configuration is provided in candidate cell configuration (or the UE selects the carrier for which RACH configuration for early TA is provided for the candidate cell). This is feasible if the network has information about the latest DL measurements results of the candidate cell. One drawback of this approach is that due to time interval between candidate cell configuration signaling and command for early TA, carrier selection performed by the network may not be valid at the time early TA procedure is initiated by the UE.

A UE then selects the UL BWP of identified carrier of identified candidate cell at step 17. Note that candidate cell is a non-serving cell and there is no active UL or DL BWP for non-serving cell. A UE needs to identify which UL BWP from candidate cell configuration is used by the UE for RA preamble transmission. Candidate cell configuration may include one or more BWP configurations.

In an embodiment, BWP indicated by firstActiveUplinkBWP field in configuration of candidate cell is selected by the UE.

In an embodiment, BWP Id of UL to be used can be indicated in PDCCH order.

In an embodiment, BWP indicated by initialUplinkBWP field in configuration of candidate cell is selected by the UE.

In an embodiment, if PRACH occasions are configured in BWP indicated by firstActiveUplinkBWP field in configuration of candidate cell, a UE selects this BWP. Otherwise, the UE selects BWP indicated by initialUplinkBWP in configuration of candidate cell.

The UL BWP information of candidate cell to be used for early TA can be signaled in an RRC reconfiguration message. The BWP information of candidate cell to be used for early TA can be signaled in LTM configuration separately (separate IEs) from the candidate cell configuration (the part that need to be applied at cell switch).

In case response to RA preamble transmission is expected and is received by monitoring the DL of the candidate cell for RA, a UE selects DL BWP of the candidate cell in similar manner as UL BWP. The UE monitors PDCCH in PDCCH monitoring occasions configured by RAR search space in selected DL BWP. If RAR search space is not configured, the UE may monitor PDCCH in PDCCH monitoring occasions configured by search space zero or any other common search space.

In an embodiment, BWP indicated by firstActiveDownlinkBWP field in configuration of candidate cell is selected by the UE.

In an embodiment, BWP Id of DL to be used can be indicated in a PDCCH order.

In an embodiment, BWP indicated by initialDownlinkBWP field in configuration of candidate cell is selected by a UE.

In an embodiment, if PRACH occasions are configured in BWP indicated by firstActiveUplinkBWP field configuration of candidate cell, a UE selects this firstActiveDownlinkBWP. Otherwise, the UE selects BWP indicated by initialDownlinkBWP in configuration of candidate cell.

In an embodiment, a UE selects DL BWP having the same BWP Id as the UL BWP selected by the UE.

The DL BWP information of candidate cell to be used for early TA can be signaled in an RRC reconfiguration message. The BWP information of candidate cell to be used for early TA can be signaled in LTM configuration separately (separate IEs) from the candidate cell configuration (the part that need to be applied at cell switch).

In case response to RA preamble transmission is expected from serving cell, a UE monitors active DL BWP of SpCell. The UE monitors PDCCH in PDCCH monitoring occasions configured by RAR search space of active DL BWP of SpCell. If RAR search space in active DL BWP of SpCell is not configured, the UE may monitor PDCCH in PDCCH monitoring occasions configured by search space zero or any other common search space.

A UE then selects RA type (4 step RA or 2 step RA) at step 18.

For RA initiated by early TA command (e.g., PDCCH order) for LTM (or advanced/early TA maintenance for LTM), a UE selects 4 step RA.

Alternatively, the UE selects the RA type whose configuration is included in selected BWP of candidate cell.

Alternatively, the UE selects the RA type indicated in early TA command (e.g., PDCCH order).

Alternatively, the UE selects the RA type based on RSRP threshold.

The UE then select the SSB of identified candidate cell at step 19.

In an embodiment, if an SSB index field is included in early TA command (e.g., PDCCH order) for LTM (or advanced TA maintenance for LTM) or if a field in early TA command (e.g., PDCCH order) indicates that SSB index field is included in early TA command (e.g., PDCCH order) or if RRC has not indicated a UE to ignore SSB index field in early TA command (e.g., PDCCH order) for LTM (or advanced TA maintenance for LTM). The UE selects the SSB indicated by this field.

In an embodiment, if an SSB index field is not included in early TA command (e.g., PDCCH order) for LTM (or advanced TA maintenance for LTM) or if RRC has indicated a UE to ignore SSB index field in early TA command (e.g., PDCCH order) for LTM (or advanced TA maintenance for LTM) or a field in early TA command (e.g., PDCCH order) indicates that SSB index field is not included in early TA command (e.g., PDCCH order), the UE selects the SSB as follows: if at least one of the SSBs with SS-RSRP above rsrp-ThresholdSSB is available: the UE selects an SSB with SS-RSRP above rsrp-ThresholdSSB. Otherwise, selects any SSB.

In an embodiment, for early TA management, contention free RACH resources for one or more SSBs are provided by a network in candidate cell configuration (e.g., in candidate cell configuration in step 10). A UE selects an SSB with SS-RSRP above threshold amongst these SSBs. This is feasible if the network has information about the latest DL measurements results of the candidate cell. One drawback of this approach is that due to time interval between candidate cell configuration signaling and command for early TA, SSBs selected by the network may not be valid at the time early TA procedure is initiated by the UE.

The UE then select RA resources (preamble, RACH occasion) for RA preamble transmission at step 20. In case of 2 step RA a UE may also select PUSCH occasion for MsgA MAC PDU transmission.

The UE then transmits RA preamble at step 21 using RACH resources of selected UL BWP of selected UL carrier. Selected RA preamble is the preamble indicated in early TA command (e.g., PDCCH order) or a preamble corresponding to selected SSB in the candidate cell's configuration. Preamble is transmitted in PRACH occasion corresponding to selected SSB.

In one embodiment, preamble power is provided. In this case, RAR is not configured for PDCCH ordered RACH for LTM (or advanced/early TA maintenance for LTM), early TA command (e.g., PDCCH order) can include value of PREAMBLE_POWER_RAMPING_COUNTER. A UE may initialize the value of PREAMBLE_POWER_RAMPING_COUNTER to value received in early TA command (e.g., PDCCH order) when RA is initiated. Alternatively, a UE maintain PREAMBLE_POWER_RAMPING_COUNTER across multiple random access procedures per candidate serving cell or group of candidate cells having same TA. If RAR is configured for PDCCH ordered RACH for LTM (or advanced/early TA maintenance for LTM), a UE sets PREAMBLE_POWER_RAMPING_COUNTER to 1 when RACH is initiated. A UE determines the power for transmission using PREAMBLE_POWER_RAMPING_COUNTER.

Based on the random access, a candidate cell determines the TA value. A candidate cell provides the same to a UE in response (e.g., in RAR or in MAC CE) at step 22 (alt1 and alt 2 in FIGS. 7B and 7C). In alt 1, a UE monitors PDCCH of SpCell. In alt2, a UE monitors PDCCH of candidate cell. In case serving cell and candidate cell belongs to different DU, target DU/candidate cell sends the TA value to source DU/serving cell in alt 1 as shown in FIG. 7C, Alternatively, a target DU/candidate cell may send the TA value to CU and CU sends the TA to a source DU/serving cell.

In case a serving cell and a candidate cell belong to the same DU, the candidate cell shares the TA value to serving cell within the DU in alt 1 as shown in FIG. 7B. If the UE receives the TA value, the candidate cell may start timing alignment timer for the TAG of candidate cell and stores the received TA. The stored value of TA is removed if timing alignment timer expires. Alternately candidate cell can provide the TA value to source cell which then sends the TA value to the UE in L1 or L2 cell change/switch command (MAC CE or DCI) at step 22 (alt 3 in FIG. 7B and FIG. 7C).

Alternatively, a candidate cell stores the TA value and when a source cell (e.g., when source cell decides to switch the UE to this candidate cell) asks the candidate cell for TA value, candidate sends TA value to source cell and the TA value received by serving cell from candidate cell (serving cell/source DU may receive TA from target DU/candidate cell directly or via CU wherein target DU/candidate cell send the TA to CU and CU sends the value to source DU/serving cell) is sent by the source cell to the UE in L1 or L2 cell change/switch command (MAC CE or DCI) at step 22 (alt 4 in FIG. 7B and FIG. 7C).

In case the TA value is sent by source cell to the UE in L1 or L2 cell change/switch command (MAC CE or DCI), the TA value may indicate the value of time alignment timer in the command and the UE starts time alignment timer with the value indicated in command. In case the TA value is sent by source cell to the UE in L1 or L2 cell change/switch command (MAC CE or DCI), the TA value may indicate the value X in the command and the UE starts time alignment timer with the value=value of time alignment timer configuration in an RRC reconfiguration message−X.

Upon transmitting the RA preamble to the candidate cell for early TA management, the UE can receive RAR (in case RAR is configured) as follows: (1) a UE can monitor the DL of candidate cell to which the UE has transmitted the RA preamble (Alt 2 in FIG. 7B and FIG. 7C) and (2) a UE monitors the DL of SpCell (Alt 1 in FIG. 7B and FIG. 7C).

In one example (e.g., approach 1), a candidate cell directly provides the same to a UE in response. This monitoring of candidate cell (e.g., a non-serving cell) may interrupt the DL monitoring of serving cells depending on UE capability. In one example (e.g., approach 2), a UE monitors DL of SpCell for response. In case SpCell and candidate cell belongs to different DU, target DU/candidate cell needs to send the TA value to source DU/SpCell.

In one embodiment, an indication to select approach 1 or approach 2 can be sent by a gNB in configuration (e.g., in candidate cell configuration in step 10). In an embodiment, in case of intra DU scenario (serving cell and candidate cell belongs to same DU), a network can indicate approach 2 in candidate cell configuration. Otherwise, the network can indicate approach 1.

In case RAR is not configured for PDCCH ordered RA for LTM (or advanced/early TA maintenance for LTM), a random access procedure is successfully completed upon transmission of PRACH preamble and CFRA resources are released.

In case RAR is configured for PDCCH ordered RA for LTM (or advanced/early TA maintenance for LTM), a random access procedure is completed upon successful reception of RAR (i.e., PDCCH addressed to RA-RNTI and RAR MAC PDU includes UE's RAPID) and CFRA resources are released. In this case, a UE may store the TA value received in RAR and starts the timing alignment timer for the TAG of candidate cell. In this case upon transmitting the RA preamble, the UE may monitor PDCCH for RAR reception in RAR window. PDDCH can be received from candidate cell or from SpCell. PDCCH can be addressed to RA-RNTI (in this case the UE may receive RAR MAC PDU with TA value). PDCCH can be addressed to CRNTI (in this case the UE may receive TB which includes absolute timing command MAC CE with TA value).

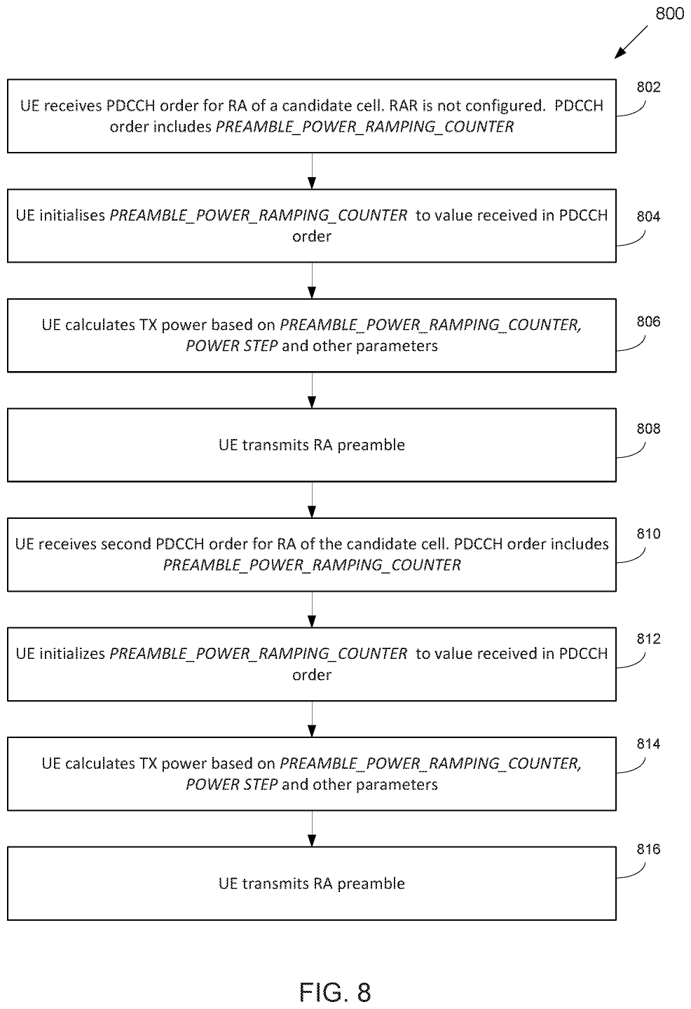

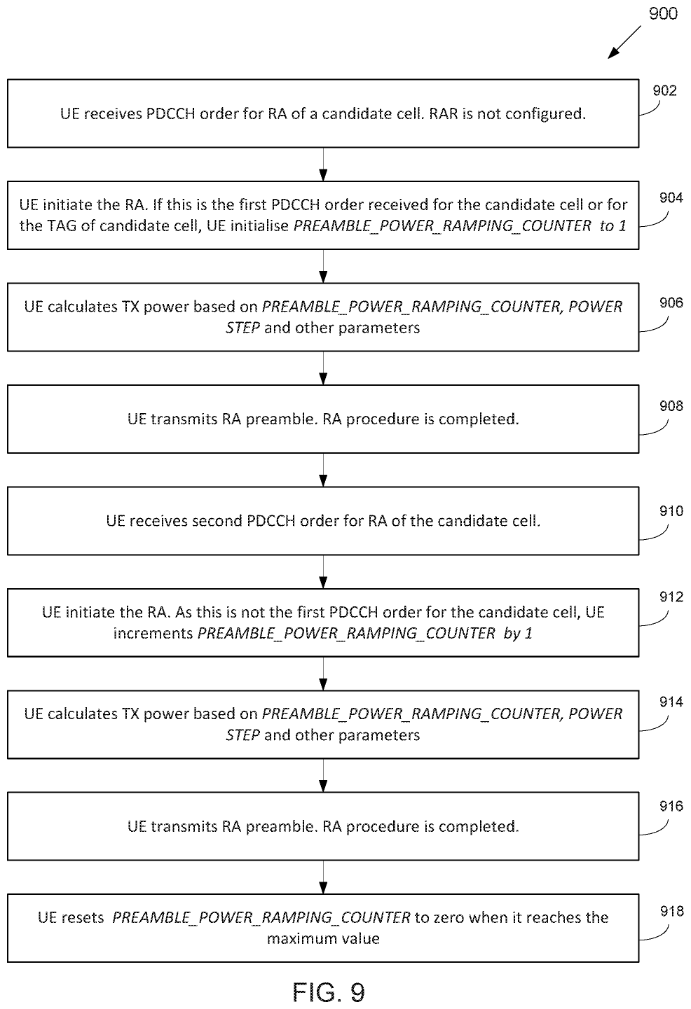

FIGS. 8 and 9 illustrate examples of UE methods 800 and 900 for preamble power for advance TA maintenance according to embodiments of the present disclosure. The method 800 and 900 as may be performed by a UE (e.g., 111-116 as illustrated in FIG. 1). An embodiment of the procedures 800 and 900 shown in FIGS. 8 and 9 are for illustration only. One or more of the components illustrated in FIGS. 8 and 9 can be implemented in specialized circuitry configured to perform the noted functions or one or more of the components can be implemented by one or more processors executing instructions to perform the noted functions.

In case RAR is not configured for PDCCH ordered RACH for LTM (or advanced TA maintenance for LTM), a PDCCH order can include value of PREAMBLE_POWER_RAMPING_COUNTER. A UE may initialize the value of PREAMBLE_POWER_RAMPING_COUNTER to value received in PDCCH order when RA is initiated as shown in FIG. 8.

As illustrated in FIG. 8, in step 802, a UE receives PDCCH order for RA of a candidate cell. RAR is not PDCCH order includes PREAMBLE_POWER_RAMPING_COUNTER.

In step 804, the UE initializes PREAMBLE_POWER_RAMPING_COUNTER to value received in PDCCH order.

In step 806, the UE calculates TX power based on PREAMBLE_POWER_RAMPING_COUNTER, POWER STEP and other parameters.

In step 808, the UE transmits RA preamble.

In step 810, the UE receives second PDCCH order for RA of the candidate cell. PDCCH order includes PREAMBLE_POWER_RAMPING_COUNTER.

In step 812, the UE initializes PREAMBLE_POWER_RAMPING_COUNTER to value received in PDCCH order.

In step 814, the UE calculates TX power based on PREAMBLE_POWER_RAMPING_COUNTER, POWER STEP and other parameters.

In step 816, the UE transmits RA preamble.

Alternately, a UE maintain PREAMBLE_POWER_RAMPING_COUNTER across multiple random access procedures per candidate serving cell or group of candidate cells having same TA as shown in FIG. 9.

In step 902, a UE receives PDCCH order for RA of a candidate cell. RAR is not configured.

In step 904, the UE initiate the RA. If this is the first PDCCH order received for the candidate cell or for the TAG of candidate cell, UE initializes PREAMBLE_POWER_RAMPING_COUNTER to 1.

In step 906, the UE calculates TX power based on PREAMBLE_POWER_RAMPING_COUNTER, POWER STEP and other parameters.

In step 908, the UE transmits RA preamble. RA procedure is completed.

In step 910, the UE receives second PDCCH order for RA of the candidate cell.

In step 912, the UE initiate the RA. As this is not the first PDCCH order for the candidate cell, UE increments PREAMBLE_POWER_RAMPING_COUNTER by 1.

In step 914, the UE calculates TX power based on PREAMBLE_POWER_RAMPING_COUNTER, POWER STEP and other parameters.

In step 916, the UE transmits RA preamble. RA procedure is completed.

In step 918, the UE resets PREAMBLE_POWER_RAMPING_COUNTER to zero when it reaches the maximum value.

In one embodiment, upon receiving the early TA command (e.g., PDCCH order), a UE initiates random access procedure and transmits the random access preamble. After transmitting the random access preamble, the UE monitors PDCCH addressed to RA-RNTI. Random access procedure is successfully completed when U the E receives RAR MAC PDU which includes MAC subPDU with random access preamble identifier corresponding to the transmitted PREAMBLE_INDEX. The UE further checks if this random access procedure was initiated for early TA management (or early TA management of candidate cell or TAG) or not.

If this random access procedure was initiated for early TA management of candidate cell (or TAG) for LTM, the UE or MAC entity in UE: (1) process the received timing advance command; (2) ignores/discards the received UL grant; and (3) does not indicate the preambleReceivedTargetPower and the amount of power ramping applied to the latest Random Access Preamble transmission to lower layers (i.e., (PREAMBLE_POWER_RAMPING_COUNTER−1)×PREAMBLE_POWER_RAMPING_STEP). Else, the UE: processes the received timing Advance command; (2) indicates the preambleReceivedTargetPower and the amount of power ramping applied to the latest Random Access Preamble transmission to lower layers (i.e., (PREAMBLE_POWER_RAMPING_COUNTER−1)×PREAMBLE_POWER_RAMPING_STEP); and (3) processes the received UL grant value and indicate the value to the lower layers (i.e., use the value to transmit UL MAC PDU to a gNB).

In another embodiment, upon receiving the PDCCH order a UE initiates random access procedure and transmits the random access preamble. After transmitting the random access preamble, the UE monitors PDCCH addressed to RA-RNTI. A random access procedure is successfully completed when the UE receives RAR MAC PDU which includes MAC subPDU with random access preamble identifier corresponding to the transmitted PREAMBLE_INDEX. The UE further checks if this random access procedure was initiated for early TA management (or early TA management of candidate cell or TAG) or not.

If this random access procedure was initiated for early TA management of candidate cell (or TAG) for LTM, the UE or MAC entity in a UE: (1) processes the received timing advance command; (2) stores the received UL grant (this UL grant is for candidate cell to which the UE has transmitted RA preamble); and (3) later when the UE receives the cell switch command for the candidate cell, the UE uses the stored UL grant to send confirmation (i.e., first UL transmission (e.g., MAC PDU) to candidate cell after switching). If there is no MAC PDU transmission to candidate cell is scheduled, the UE can simply discard the stored UL grant or send padding MAC PDU. Else, the UE: (1) processes the received timing advance command; and (2) processes the received UL grant value and indicate the value to the lower layers (i.e., use the value to transmit UL MAC PDU to a gNB).

Alternately, if this random access procedure was initiated for early TA management of candidate cell (or TAG) for LTM, a UE or MAC entity in a UE: (1) processes the received timing advance command; (2) stores the received UL grant (this UL grant is for candidate cell to which the UE has transmitted RA preamble). The UE discards the stored UL grant after a configured time interval (this time interval or for this time interval a timer value can be configured by a gNB via RRC signaling); and (3) later when the UE receives the cell switch command for the candidate cell, the UE uses the stored UL grant (if not yet discarded) to send confirmation (i.e., first UL transmission to candidate cell after switching). If there is no MAC PDU transmission to candidate cell is scheduled, the UE can simply discard the stored UL grant or send padding MAC PDU.

Else, the UE: (1) processes the received timing advance command; and (2) processes the received UL grant value and indicate the value to the lower layers (i.e., use the value to transmit UL MAC PDU to a gNB).

Alternately, if this random access procedure was initiated for early TA management of candidate cell (or TAG) for LTM, a UE or MAC entity in a UE: (1) processes the received timing advance command; and (2) if a gNB has indicated (e.g., in candidate cell configuration or RRC configuration) to store the UL grant: (i) the UE stores the received UL grant (this UL grant is for candidate cell to which the UE has transmitted RA preamble), and (ii) later when the UE receives the cell switch command for the candidate cell, the UE uses the stored UL grant to send confirmation (i.e., first UL transmission to candidate cell after switching). If there is no MAC PDU transmission to candidate cell is scheduled, the UE can simply discard the stored UL grant or send padding MAC PDU. Else, the UE ignores/discards the UL grant.

The UE processes the received timing advance command. The UE processes the received UL grant value and indicate the value to the lower layers (i.e., use the value to transmit UL MAC PDU to a gNB).

Alternately, if this random access procedure was initiated for early TA management of candidate cell (or TAG) for LTM, a UE or MAC entity in a UE: (1) processes the received timing advance command; (2) if a gNB has indicated (e.g., in candidate cell configuration or RRC configuration) to store the UL grant: (i) the UE stores the received UL grant (this UL grant is for candidate cell to which the UE has transmitted RA preamble). The UE discards the stored UL grant after a configured time interval (this time interval or for this time interval a timer value can be configured by the gNB via RRC signaling), (ii) later when the UE receives the cell switch command for the candidate cell, the UE uses the stored UL grant (if not yet discarded) to send confirmation (i.e., first UL transmission to candidate cell after switching). If there is no MAC PDU transmission to candidate cell is scheduled, the UE can simply discard the stored UL grant or send padding MAC PDU, else (iii) otherwise, the UE ignores/discards the UL grant.

Else, the UE processes: the received timing advance command; and (2) the received UL grant value and indicate the value to the lower layers (i.e., use the value to transmit UL MAC PDU to the gNB).

A candidate cell (non-serving cell) in an LTM configuration received by a UE from a gNB in an RRCReconfiguration message is associated with a TAG (e.g., TAG B). The UE (re) starts a TAT timer T1 for this TAG i.e., TAG B when TA (e.g., in RAR or MsgB or in MAC CE) is received by the UE from the gNB for this TAG i.e., TAG B. The value of TAT timer for this TAG i.e., TAG B is indicated by parameter timeAlignmentTimer received by the UE from the gNB in the RRCReconfiguration message. The parameter timeAlignmentTimer is signaled per TAG.

An SpCell (PCell of MCG or PSCell of SCG) is associated with a TAG (i.e., TAG A). A UE (re) starts a TAT timer T2 for this TAG i.e., TAG A when TA (e.g., in RAR or MsgB or in MAC CE) is received by the UE from the gNB for this TAG i.e., TAG A. TAG for SpCell is also referred as PTAG. The value of TAT timer for this TAG i.e., TAG A is indicated by parameter timeAlignmentTimer received by the UE from the gNB in an RRCReconfiguration message.

In one example, when TAT of PTAG expires, MAC entity (note that there is separate MAC entity for MCG and SCG in UE) in the UE stops all running TATs in that MAC entity. TATs associated with serving cell as well as the TATs associated with LTM candidate cell(s) for which TA is established are stopped. This is not the desired behavior for L1/L2 triggered mobility. This operation may require network (i.e., gNB) to unnecessarily send PDCCH order to establish early TA for non-serving cell again or the UE may perform RACH upon receiving cell switch command. This leads to unnecessary signaling overhead and increased latency for LTM if TA could not be re-established again before the cell switch command is sent.

In one embodiment, upon expiry of TAT of PTAG, MAC entity in a UE, keeps TAT for a non-serving cell (e.g., candidate cell for LTM) running if TAG of the non-serving cell is not the same as TAG of any serving cell of MAC entity. Upon expiry of TAT of SpCell, TATs associated with TAGs of all activated serving cells are stopped.

In an embodiment, TAG of a non-serving cell (e.g., candidate cell for LTM) is different from TAG of serving cells. TAT is running for a non-serving cell, SpCell and SCell in MAC entity. TAG of non-serving cell (e.g., candidate cell for LTM) is TAG B, TAG of SPCell is TAG A and TAG of Scell is TAG C. Upon expiry of TAT for TAG A, MAC entity in the UE stops TAT of TAG A and TAT of TAG C. The UE does not stop TAT of TAG B.

In an embodiment, TAG of a non-serving cell (e.g., candidate cell for LTM) is same as TAG of Scell. TAT is running for a non-serving cell, SpCell and Scell in MAC entity. TAG of non-serving cell (e.g., candidate cell for LTM) is TAG B, TAG of SPCell is TAG A and TAG of Scell is TAG B. Upon expiry of TAT for TAG A, MAC entity in the UE stops TAT of TAG A and TAT of TAG B.

In an embodiment, TAG of a non-serving cell (e.g., candidate cell for LTM) is same as TAG of SpCell. TAT is running for a non-serving cell, SpCell in MAC entity. TAG of non-serving cell (e.g., candidate cell for LTM) is TAG A, TAG of SPCell is TAG A. Upon expiry of TAT for TAG A, MAC entity in the UE stops TAT of TAG A.

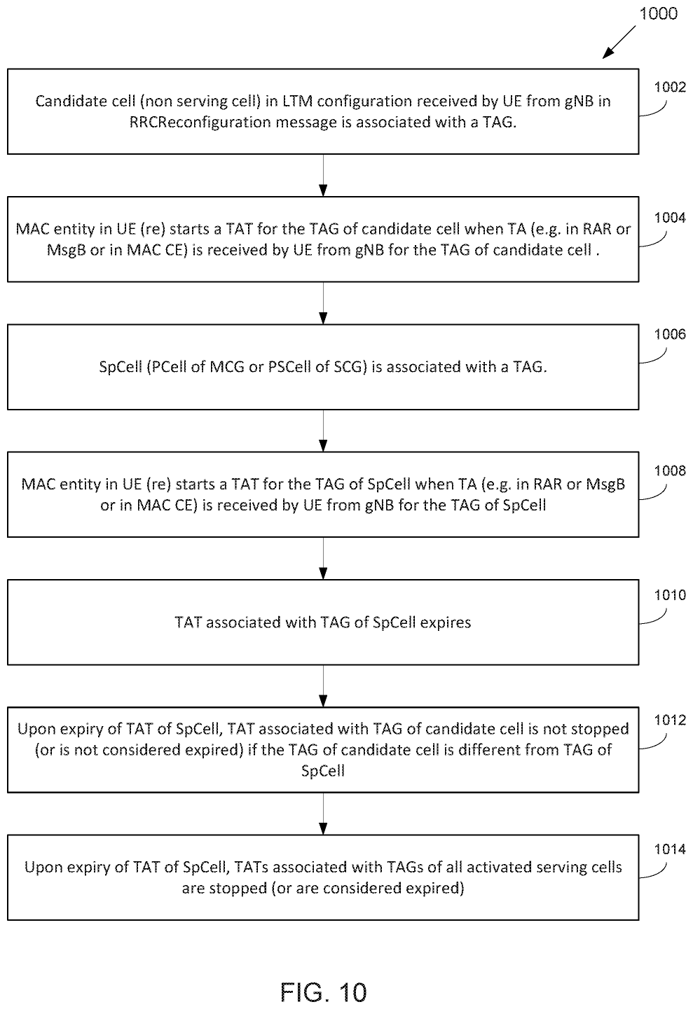

FIG. 10 illustrates an example of UE method 1000 for a lower layer signaling based mobility procedures 1000 according to embodiments of the present disclosure. The method 1000 as may be performed by a UE (e.g., 111-116 as illustrated in FIG. 1). An embodiment of the method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

In step 1002, the UE identifies a candidate cell (e.g., a non-serving cell) in LTM configuration received by UE from gNB in RRCReconfiguration message is associated with a TAG.

In step 1004, the UE MAC entity in (re) starts a TAT for the TAG of candidate cell when TA (e.g., in RAR or MsgB or in MAC CE) is received by UE from gNB for the TAG of candidate cell.

In step 1006, the SpCell (Pcell of MCG or PSCell of SCG) is associated with a TAG.

In step 1008, the UE MAC entity (re) starts a TAT for the TAG of SpCell when TA (e.g., in RAR or MsgB or in MAC CE) is received by UE from gNB for the TAG of SpCell. In step 1010, the TAT is associated with TAG of SpCell expires.

In step 1012, upon expiry of TAT of SpCell, TAT associated with TAG of candidate cell is not stopped (or is not considered expired) if the TAG of candidate cell is different from TAG of SpCell.

In step 1014, Upon expiry of TAT of SpCell, TATs associated with TAGs of all activated serving cells are stopped (or are considered expired).

In one embodiment, the operation of MAC entity in a UE upon expiry of TAT (timeAlignmentTimer) is as shown in TABLE 1.

TABLE 1

| | |
|---|---|
| 1> | when a timeAlignmentTimer expires: |
| 2> | if the timeAlignmentTimer is associated with the PTAG: |
| 3> | flush all HARQ buffers for all serving cells; |
| 3> | notify RRC to release PUCCH for all serving cells, if configured; |
| 3> | notify RRC to release SRS for all serving cells, if configured; |
| 3> | clear any configured downlink assignments and configured uplink grants; |
| 3> | clear any PUSCH resource for semi-persistent CSI reporting; |
| 3> | consider all running timeAlignmentTimers associated with TAGs of all activated |
| | serving cells as expired; |
| 3> | maintain NTA (defined in TS 38.211) of all TAGs. |

In an embodiment, timeAlignmentTimerLTM is defined for early TA maintenance of a non-serving cells (i.e., candidate cells for LTM). timeAlignmentTimerLTM is signaled by a gNB in an RRC reconfiguration message.

When a UE/MAC entity receives TA from the gNB in response to PRACH preamble transmitted by a UE for early TA to a candidate cell, the UE restarts timeAlignmentTimerLTM for the TAG of cell to which UE has transmitted PRACH preamble.

In an embodiment, if the TAG of cell to which a UE has transmitted PRACH is also associated with a serving cell, the UE also (re)starts timeAlignmentTimer for the TAG.

When a UE/MAC entity receives TA from the gNB in response to contention free PRACH preamble transmitted by a UE for early TA to a candidate cell, the UE restarts timeAlignmentTimerLTM for the TAG of cell to which the UE has transmitted PRACH preamble.

In an embodiment, If the TAG of cell to which a UE has transmitted PRACH is also associated with a serving cell, the UE also (re)starts timeAlignmentTimer for the TAG.

When a UE/MAC entity receives TA from the gNB in response to contention based PRACH preamble transmitted by a UE for early TA to a candidate cell and timeAlignmentTimerLTM is not running, the UE starts time AlignmentTimerLTM for the TAG of cell to which the UE has transmitted PRACH preamble.

In an embodiment, If the TAG of cell to which the UE has transmitted PRACH is also associated with a serving cell, the UE also (re)starts timeAlignmentTimer for the TAG.

When a UE/MAC entity receives TA from the gNB in response to PRACH preamble transmitted by a UE to a serving cell and the UE restarts timeAlignmentTimer for the TAG of serving cell to which the UE has transmitted PRACH preamble, if the TAG of serving cell is also associated with any non-serving cell (i.e., candidate LTM cell), the UE also (re)starts timeAlignmentTimerLTM for the TAG.

When a UE/MAC entity receives TA from the gNB for a TAG of serving cell and the UE (re)starts time AlignmentTimer for the TAG of serving cell, if the TAG is also associated with any non-serving cell (i.e., candidate LTM cell), the UE also (re)starts timeAlignmentTimerLTM for the TAG.

When a UE/MAC entity receives TA from the gNB for a TAG, if TAG is associated with a serving cell, the UE (re)starts time AlignmentTimer for the TAG. If TAG is associated with a non-serving cell (i.e., candidate LTM cell), the UE (re)starts time AlignmentTimer for the TAG.

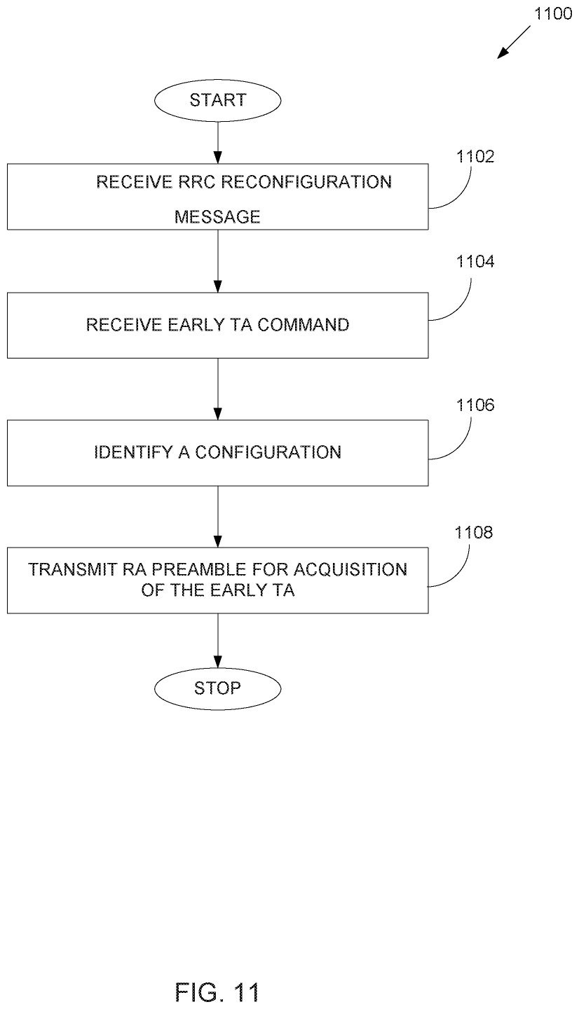

FIG. 11 illustrates a flowchart of a UE method 1100 for a random access procedure with a lower layer signaling based mobility control according to embodiments of the present disclosure. The UE methods 1300 as may be performed by a UE (e.g., 111-116 as illustrated in FIG. 1). An embodiment of the UE method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, the method 1100 begins at step 1102. In step 1102, a UE receives, an RRC reconfiguration message including a set of configurations of candidate cells for LTM.

In one example, the RRC reconfiguration message further includes uplink bandwidth part (UL BWP) information of the candidate cell for the acquisition of the early TA.

In step 1104, the UE receives an early TA command for acquisition of an early TA, the early TA command indicating a candidate cell configuration index, identifies, based on the RRC reconfiguration message, a configuration from the set of configurations associated with the candidate cell configuration index, and transmits, based on the configuration, a RA preamble for the acquisition of the early TA for a candidate cell associated with the candidate cell configuration index.

In one example, the configuration associated with the candidate cell configuration index includes a first configuration for the acquisition of the early TA and a second configuration for a cell switch and the first configuration for the acquisition of the early TA is included in an IE that is different from an IE carrying the second configuration for the cell switch.

In one example, the early TA command indicates a non-zero RA preamble index, an index of SSB, and an uplink carrier for the acquisition of the early TA.

In one example, the configuration associated with the candidate cell configuration index includes at least one of a configuration for the acquisition of the early TA for a supplementary uplink carrier and a configuration for acquisition of the early TA for a normal uplink carrier.

In one example, the configuration for acquisition of the early TA for an uplink carrier includes UL BWP information, a random access configuration, and an absoluteFrequencyPointA. In one embodiment, the UE selects a type of the RA procedure as 4-step RA.

In one embodiment, the UE receives a TA of the candidate cell, wherein the TA of the candidate cell is identified based on the RA preamble, and wherein the TA of the candidate cell is included in a cell switch command MAC CE.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to:
receive a radio resource control (RRC) reconfiguration message including a set of configurations of candidate cells for layer 1/layer 2-triggered mobility (LTM), and
receive an early timing advance (TA) command for acquisition of an early TA, the early TA command indicating a candidate cell configuration index; and
a processor operably coupled to the transceiver, the processor configured to identify, based on the RRC reconfiguration message, a configuration from the set of configurations associated with the candidate cell configuration index, and
wherein the transceiver is further configured to transmit, based on the configuration, a random access (RA) preamble for the acquisition of the early TA for a candidate cell associated with the candidate cell configuration index.

2. The UE of claim 1, wherein:
the configuration associated with the candidate cell configuration index includes a first configuration for the acquisition of the early TA and a second configuration for a cell switch; and
the first configuration for the acquisition of the early TA is included in an information element (IE) that is different from an IE carrying the second configuration for the cell switch.

3. The UE of claim 2, wherein the configuration associated with the candidate cell configuration index includes at least one of a configuration for the acquisition of the early TA for a supplementary uplink carrier and a configuration for acquisition of the early TA for a normal uplink carrier.

4. The UE of claim 2, wherein the configuration for the acquisition of the early TA for an uplink carrier includes (i) uplink bandwidth part (UL BWP) information, (ii) a RA configuration, and (iii) an absoluteFrequencyPointA.

5. The UE of claim 2, wherein the RRC reconfiguration message further includes uplink bandwidth part (UL BWP) information of the candidate cell for the acquisition of the early TA.

6. The UE of claim 1, wherein the early TA command indicates (i) a non-zero RA preamble index, (ii) an index of SSB, and (iii) an uplink carrier for the acquisition of the early TA.

7. The UE of claim 1, wherein the processor is further configured to select a type of a RA procedure as 4-step RA.

8. The UE of claim 1, wherein:
the transceiver is further configured to receive a TA of the candidate cell,
the TA of the candidate cell is identified based on the RA preamble, and
the TA of the candidate cell is included in a cell switch command medium access control-element (MAC CE).

9. A method of a user equipment (UE) in a wireless communication system, the method comprising:
receiving a radio resource control (RRC) reconfiguration message including a set of configurations of candidate cells for layer 1/layer 2-triggered mobility (LTM);
receiving an early timing advance (TA) command for acquisition of an early TA, the early TA command indicating a candidate cell configuration index;
identifying, based on the RRC reconfiguration message, a configuration from the set of configurations associated with the candidate cell configuration index; and
transmitting, based on the configuration, a random access (RA) preamble for the acquisition of the early TA for a candidate cell associated with the candidate cell configuration index.

10. The method of claim 9, wherein:
the configuration associated with the candidate cell configuration index includes a first configuration for the acquisition of the early TA and a second configuration for a cell switch; and
the first configuration for the acquisition of the early TA is included in an information element (IE) that is different from an IE carrying the second configuration for the cell switch.

11. The method of claim 10, wherein the configuration associated with the candidate cell configuration index includes at least one of a configuration for the acquisition of the early TA for a supplementary uplink carrier and a configuration for acquisition of the early TA for a normal uplink carrier.

12. The method of claim 10, wherein the configuration for the acquisition of the early TA for an uplink carrier includes (i) uplink bandwidth part (UL BWP) information, (ii) a RA configuration, and (iii) an absoluteFrequencyPointA.

13. The method of claim 10, wherein the RRC reconfiguration message further includes uplink bandwidth part (UL BWP) information of the candidate cell for the acquisition of the early TA.

14. The method of claim 9, wherein the early TA command indicates (i) a non-zero RA preamble index, (ii) an index of SSB, and (iii) an uplink carrier for the acquisition of the early TA.

15. The method of claim 9, further comprising selecting a type of a RA procedure as 4-step RA.

16. The method of claim 9, further comprising receiving a TA of the candidate cell,
wherein the TA of the candidate cell is identified based on the RA preamble, and wherein the TA of the candidate cell is included in a cell switch command medium access control-element (MAC CE).

17. A base station (BS) in a wireless communication system, the BS comprising:
a processor; and
a transceiver operably coupled to the processor, the transceiver configured to:
transmit, a radio resource control (RRC) reconfiguration message including a set of configurations of candidate cells for layer 1/layer 2-triggered mobility (LTM),
transmit an early timing advance (TA) command for acquisition of an early TA, the early TA command indicating a candidate cell configuration index, wherein a configuration from the set of configurations associated with the candidate cell configuration index is identified based on the RRC reconfiguration message, and
receive, based on the configuration, a random access (RA) preamble for the acquisition of the early TA for a candidate cell associated with the candidate cell configuration index.

18. The BS of claim 17, wherein:
the configuration associated with the candidate cell configuration index includes a first configuration for the acquisition of the early TA and a second configuration for a cell switch; and
the first configuration for the acquisition of the early TA is included in an information element (IE) that is different from an IE carrying the second configuration for the cell switch.

19. The BS of claim 18, wherein:
the configuration associated with the candidate cell configuration index includes at least one of a configuration for acquisition of the early TA for a supplementary uplink carrier and a configuration for acquisition of the early TA for a normal uplink carrier;
the configuration for acquisition of the early TA for an uplink carrier includes (i) uplink bandwidth part (UL BWP) information, (ii) a RA configuration, and (iii) an absoluteFrequencyPointA; and
the RRC reconfiguration message further includes uplink bandwidth part (UL BWP) information of the candidate cell for the acquisition of the early TA.

20. The BS of claim 17, wherein:
the transceiver is further configured to transmit a TA of the candidate cell,
the TA of the candidate cell is identified based on the RA preamble, and
the TA of the candidate cell is included in a cell switch command medium access control-control element (MAC CE).
